(19) United States
(12) Patent Application Publication
(10) Pub. No.: US 2015/0177722 A1
(43) Pub. Date: Jun. 25, 2015

(54) UTILITY CONTROL SYSTEM

(71) Applicant: MARK KIT JIUN CHAN, Hong Kong (HK)

(72) Inventor: MARK KIT JIUN CHAN, Hong Kong (HK)

(21) Appl. No.: 14/639,089

(22) Filed: Mar. 4, 2015

Related U.S. Application Data
(63) Continuation-in-part of application No. 13/081,617, filed on Apr. 7, 2011, now abandoned.
(60) Provisional application No. 61/321,913, filed on Apr. 8, 2010.

(51) Int. Cl. G05B 15/02

(52) U.S. Cl. CPC G05B 15/02

(57) ABSTRACT

A utility control system governs provision of genuine on-demand lighting, as well other utilities as in heating, ventilation and air conditioning (“HVAC”) in territories of a building in accordance with occupant demand. In lighting control, the present invention enacts on-demand lighting anterior to the occupant entering a normally dimmed/unlighted territory; lighting is provided immediately anterior to occupant entry into an oncoming territory of entry, adjoining selected territories to said oncoming territory which may or may not be entered by the occupant, in accordance with a unique lighting scene in each of those territories created by the control system or defined by the occupant. As the occupant leaves each territory, lighting provision is suspended/terminated in that territory for energy conservation. The utility control system predicts an occupant traversal path and provides the occupant with the best-suited lighted environments in each territory of the occupant traversal path.

### CROSS-REFERENCE TO RELATED APPLICATIONS

This application is a continuation-in-part of U.S. Non-Provisional patent application Ser. No. 13/081,617, filed on Apr. 7, 2011, which claims the benefits of U.S. Provisional Application No. 61/321,913, filed Apr. 8, 2010. The disclosures of U.S. Non-Provisional patent application Ser. No. 13/081,617 and of U.S. Provisional Application No. 61/321,913 are herein incorporated by reference in their entirety.

### BACKGROUND OF THE INVENTION

1. Field of the Invention

The present invention relates in particular to a sophisticated utility control system with a major breakthrough—genuine on-demand lighting provision. Illumination is activated immediately anterior to occupant entry into an oncoming territory such that the occupant is not exposed to light fixture brightening during the illumination process. Subsequent occupancy traffic and departure from a territory is tracked and analyzed by the controller in the occupancy verification process for determination of illumination extinguishment.

2. Description of Related Art

Existing utility control systems control lighting and other utilities characterized in HVAC in conformance with occupancy detection and preconfigured responses. Problems arise as illumination in a normally dimmed, sensor monitored territory is activated after sensor detection of an occupant without obviation of the occupant from the brightening process in the entered territory, or oncoming territory of immediate entry; concurrent systems do not obviate the occupant from visually experiencing the brightening process in a dimmed building territory of intended entry, building territories pertaining to a projected traversal path of entry or territories not visited by the occupant yet the lighting conditions within which are visually exposed to the occupant—even though the occupant may be detected anterior to making entry into a normally dimmed building territory. In addition, the occupant undetected by the occupancy sensing apparatuses in a territory may possibly experience termination of provision of lighting and other utilities upon the lapse of preconfigured time periods. However, to optimize power conservation, an unattended common use building territory unavoidably remains as normally dimmed and only illuminated with sensor signals verifying expectation of occupant entry and verified presence, thereby unavoidably inflicting brightening of visually exposed, dimmed territories on the visiting occupant.

There is a need in the art for a system to provide on-demand lighting with provision of illumination in territories in which the lighting conditions are visually exposed to the unvisited occupant located in an adjoining territory, including antecedent illumination as in completion of the brightening process anterior to an occupant's visual contact with the oncoming building territory and visual exposure to the brightening in a territory of entry—therefore prior to actual presence in the territory, and illumination extinguishment after verification of occupant departure through data supporting possible departure of an occupant from attended territory with undetected occupancy.

### SUMMARY OF THE INVENTION

The invention relates to a utility control system that governs lighting and other utility provision to building territories (“territories”). The invention relates to illumination of light groups with scene alterations by a modular controller governing a corresponding zone of monitored territories in conformity with embedded control methods and received sensor signals. At least one override switch is installed in each building territory for the sending of command signals to extend illumination upon activation, as well a link with the ECS to receive elevator scheduler information. In fact, the invention relates to on-demand utility control system to optimize energy efficacies, in particular a utility control apparatus governing on-demand lighting and utility control in accordance with the prediction of an occupant traversal path based on signals received from a combination of sensors and information from the ECS.

### BRIEF DESCRIPTION OF THE DRAWINGS

The drawings constitute various embodiments of the present invention and serve to depict the control infrastructure and operating principles. The features and advantages of the present invention will be apparent from the following detailed description of the invention with reference to the accompanied drawings in which:

FIG. 1 illustrates an exemplary building environment comprising a zone governed by the utility control system;

FIG. 2 illustrates an interactive sensor using various technologies and operation principles;

FIG. 3 is a flow diagram illustrating the control method of the utility control system in operation with real-time ECS operation information;

FIG. 4 illustrates an exemplary passive infrared (“PIR”) sensor performing a diagnosis function in conformity with control signals receiving from a controller;

FIG. 5 illustrates interaction of apparatuses of an exemplary modular utility control system governing one building zone;

FIG. 6 illustrates an exemplary implementation of antecedent illumination in a building environment;

FIG. 7 is a flowchart illustrating a control method of the present invention for activating antecedent illumination and an occupancy verification process; and

FIG. 8 illustrates an exemplary building environment comprising a zone of non-common use and common use territories governed by the utility control system in providing on-demand lighting.

### DETAILED DESCRIPTION OF THE INVENTION

The present invention may be better understood with reference to embodiments illustrated by the supporting drawings. However, the invention is not restricted to specific apparatuses, technologies, methods or particular protocols, which may be modified or substituted by equivalent counterparts or new approaches to serve similar purposes or functions as long as the overall operation and performance remain unimpeded and unaltered in principle. Terminology and protocol used herein is to describe particular embodiments and is not intended to be limiting in scope.

### Terminology and Terms as Used Herein:

### Client Computer

A network linked electronic device such as a microcomputer or a handheld personal digital assistant (“PDA”), etc.

### Electrical Device

Electrically operated devices controlled by the utility control system including but not limited to light fixtures, occupancy sensors and the client computer.

### Grace Time Period

Each occupant entering a territory from another territory is assigned a grace time period by the controller, during which lighting and other utility provision is to continue without disruption. The grace time period may be terminated upon detecting possible occupant exit from the territory provided with antecedent illumination and other utilities such as HVAC, through interactive sensor detection of occupant initiated actions, or elevator car departure from said territory in accordance with operational data or information received from a communicatively connected ECS.

### Lamp

The light fixture is mounted with at least one lamp, which attains lighting intensity up to preconfigured percentages of full lumens in brightness from dimmed in accordance with a unique lighting scene within a brief time duration beginning from interactive sensor detected occupant initiated action to visual exposure of the brightening, or to the territory of entry: including but not limited to the light emitting diode (“LED”), halogen lamp, incandescent lamp.

### Interactive Sensor, and Occupant Initiated Action

A sensor detecting occupant initiated action prior to making entry into an oncoming territory, which may be segregated from the concurrent occupant attended territory with a normally closed door, or openly adjoined to the concurrent occupant attended territory through a stairway. Occupant initiated actions include but not limited to: occupant approaching toward a normally closed door, touching the door installed door knob, turning the door bolt with the door knob, opening a normally closed door partitioning two territories pertaining to the occupant traversal path, insertion/withdrawal/reading of a chip embedded key/key card with a card reader, activation of a door bell, traversing through a stairway between two openly adjoined territories.

### Occupancy Sensor

A sensor monitoring occupancy and occupant location within a territory and sending sensor signal to the controller upon detecting the occupant through PIR sensing, laser sensing, imaging capturing and processing, or, a sensor detecting the traversing occupant through active sensing of a chip embedded PDA using RFID sensing and WiFi sensing, etc.

### Power Reduction Mode

An electrical device may be switched from a power reduction mode indicating either a standby mode with reduced or minimal power consumption or total power disconnection to an operation mode with full power connection to electricity and readiness for intended operation.

### Territory and Zone

A zone within a building is monitored by a controller of the utility control system and is comprised of at least one common use territory. As the traversing occupant departing from the present territory enters an oncoming territory adjacent to the present territory and reaches a destination territory—the occupant traversal path.

### On-Demand Lighting

Illumination including but not limited to antecedent illumination (as illustrated below) and occupancy verification process (also as illustrated below), comprising a process of power connection or boost to one or more totally or partially dimmed lamp mounted light fixtures—disposed in the territory to be entered by the occupant, and one or more territories adjoined to territory of occupant making entry, which is a common use territory—by sequentially or simultaneously attaining lighting intensity up to preconfigured percentages of full lumens in brightness in accordance with one or more unique lighting scenes in those territories, providing illumination over a grace time period and executing the occupancy verification process prior to deactivating the brightened light fixtures in terms of dimming.

### Antecedent Illumination

Illumination in a normally dimmed/unlighted territory is activated upon detected of occupant initiated action, immediately anterior to occupant entry and visual exposure to the territory of occupant entry—the brightening process is precluded from inflicting on the occupant.

### Occupancy Verification Process

Illumination is continuously provided over a preconfigured grace time period, upon the lapse of which the controller analyzes received sensor signals and information from the elevator control system—in particular, interactive sensor signals related to door opening for exit from the visited territory, elevator departing from an occupant attended territory in accordance with ECS scheduling, exit gate card reading in the parking garage—for determination of possible occupant departure from the territory of detected occupancy in accordance with execution of the occupant verification process, as well as territory of entry unvisited by an occupant imposing an occupant initiated action, which invariantly differs from signals of occupancy sensors showing undetected occupancy in an occupant attended territory.

### Illumination Extinguishment

Illumination extinguishment denotes lighting in the occupant attended territories are dimmed or, entering a power reduction mode, after the control system has performed an occupancy verification process for assurance of occupant departure from those territories through analysis of sensors sent signals, data and information received through a communicative linkage from an ECS, upon the lapse of a preconfigured grace time period commencing upon activation of antecedent illumination.

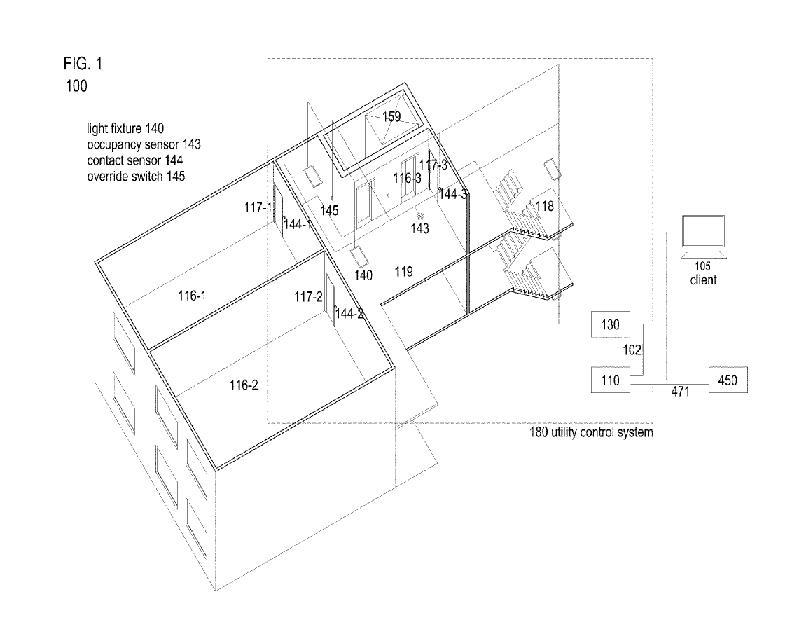

FIG. 1 illustrates an exemplary building environment 100 in which utility control system 180 monitors occupancy and controls provision of lighting. Controller 130 of utility control system 180 implements the operation and is communicatively linked to hub 110 via bus 102. Note that although wired connections are shown in FIG. 1, wireless communication of control signals can also be used by the present invention. Real-time monitoring of environment 100 and control of the operation by management is enabled through client 105, which is also linked (wired or wireless) to hub 110. Client 105 sends configurations and commands to controller 130 and receives operation information, such as power consumption, apparatus status, etc. from controller 130.

An exemplary zone encompasses elevator car (“car”) 159 serviced common use territory elevator hall 119, residence units 116-1, 116-2 as non-common use territories; installed within elevator hall 119 of the zone includes a plurality of light fixtures 140, occupancy sensors 143, interactive sensors 144-1, 144-2, 144-3 and override switch 145 which are communicatively linked to controller 130 through wired/wireless communicative linkage 102. Utility control system 180 provides antecedent illumination in a territory in anticipation of an arriving occupant (not shown).

In one embodiment, the occupant (not shown) may enter unattended elevator hall 119 from unit 116-1, unit 116-2 or stairs 118; prior to making entry, the occupant (not shown) triggers respective interactive sensor 144-1, 144-2, or 144-3, at the opening of corresponding doors 117-1, 117-2, or 117-3. A signal is sent by the pertinent interactive sensor to controller 130, which then brightens normally and concurrently dimmed light fixtures 140 from a power reduction mode to an operation mode with the light intensity ramped up to a lux level preconfigured in accordance with a unique lighting scene by controller 130 anterior to visual contact of the occupant (not shown) made with elevator hall 119—to obviate the occupant (not shown) from visual notification of the brightening process in dimmed elevator hall 119.

In another embodiment, controller 130 obtains information regarding passenger arrival (not shown) in unattended elevator hall 119 from landing car 159: an elevator car detection section (not shown)—communicatively linked with controller 130 detecting car landing—sends a signal to controller 130 upon landing of car 159; controller 130 brightens light fixtures 140 anterior to opening of elevator doors 116-3 and the occupant (not shown) experiencing visual contact with elevator hall 119 as the oncoming building territory of entry: the occupant (not shown) is precluded from notification and visual exposure to the brightening process in elevator hall 119 as the territory of entry. In an alternative embodiment, ECS 450 sends information 471 comprising landing schedules of car 159 to controller 130; controller 130 brightens light fixtures 140 anterior to opening of elevator doors 116-3 and the occupant (not shown) experiencing visual contact with elevator hall 119 as the oncoming building territory of entry: the occupant (not shown) is obviated from notification and visual exposure to the brightening process in elevator hall 119 as the territory of entry.

The occupant (not shown) entering elevator hall 119 from unit sensors 117-1 is assigned a preconfigured grace time period; which may be preconfigured in accordance with occupant identity, interactive sensor 144-1, and stored in the memory means (not shown) of controller 130, or defined through client 105 and is initiated by one or a combination of occupancy sensors, interactive sensors, elevator car detection sections, the ECS, etc. upon detection of the occupant (not shown) entering into an oncoming, normally dimmed territory. Upon depletion of the grace time period, controller 130 dims light fixtures 140 after implementing the occupancy verification process for ascertainment of occupant departure in the respective territories.

Information pertaining to units 116-1 and 116-2 mounted respective interactive sensors 144-1, 144-2 including but not limited to unit numbers, occupant identifications and associated parking spaces in a building parking garage (not shown), etc. is stored in the memory means (not shown) of controller 130. Occupant entry and exit through units 116-1 and 116-2 trigger corresponding interactive sensors 144-1, 144-2; related unique lighting scenes pertaining to each of interactive sensor 114-1, or interactive sensor 114-2, may be utilized by controller 130 for automated utility provision including on-demand lighting comprising antecedent illumination, as well as, HVAC in corresponding units 116-1, 116-2 upon occupant (not shown) entry from elevator hall 119. On the other hand, inferred occupant traversal path and destination territory may be projected by controller 130 in accordance with occupant information tagged with interactive sensors 144-1 and 144-2 upon occupant (not shown) entry into elevator hall 119: controller 130 will activate on-demand lighting comprising antecedent illumination and HVAC provision in the territories, pertaining to the inferred/projected occupant traversal path.

Further, the state of interactive sensors 144-1 and 144-2 may be utilized by controller 130 for signals recording and analyzing of occupant entry/exit contributed from unit 116-1 and unit 116-2, in control of automated utility provision in common use territories including but not limited to elevator hall 119, through activation of on-demand lighting comprising antecedent illumination and HVAC provision anterior to occupant (not shown) entry in or visual exposure to the brightening of dimmed light fixtures 140 installed in elevator hall 119 at an instantaneous time before the recorded first of the day activity detected by interactive sensors 144-1, 144-2, and the corresponding occupancy verification process prior to activating illumination extinguishment and termination of HVAC provision in the aforementioned unattended common use territories at an instantaneous time before the start of low traffic as demonstrated in controller 130 recorded data.

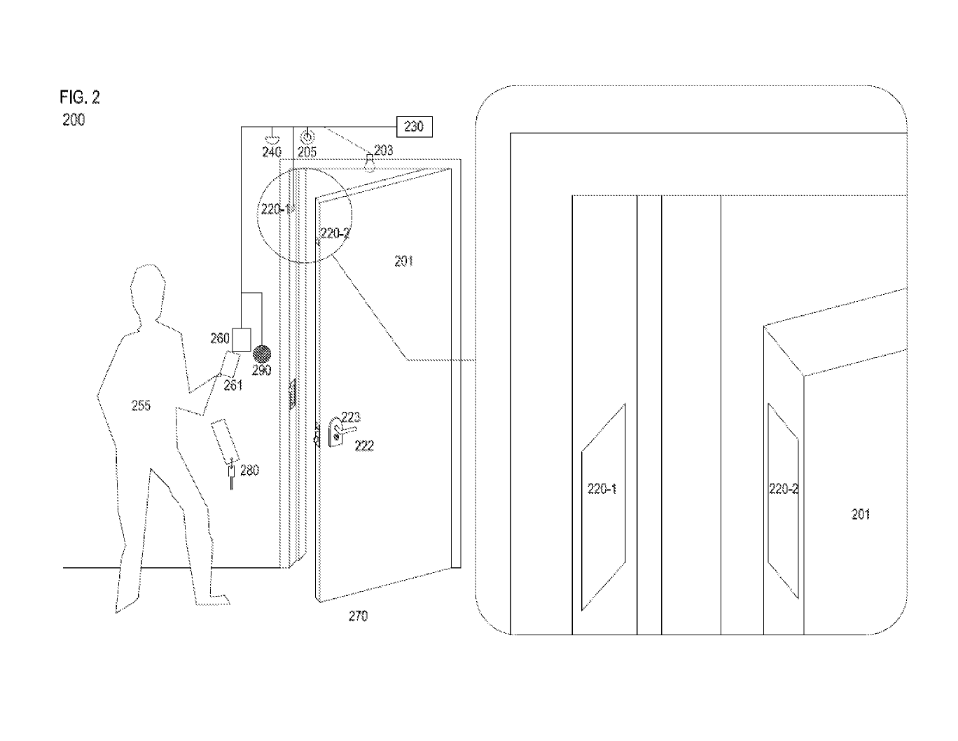

FIG. 2 illustrates various embodiments of the interactive sensor pertaining to territory 200. In one embodiment, interactive sensor 220 is a contact sensor encompassing sensing plate 220-1 mounted on the door frame and is communicatively linked to controller 230, as well as contact plate 220-2 which is mounted on door 201. When door 201 is in the closed state, sensing plate 220-1 is faced with contact plate 220-2. When the door 201 is opened by occupant 255, contact plate 220-2 moves away from sensing plate 220-1: interactive sensor 220 sends a signal to controller 230, which switches one or more electrical devices (not shown) in the oncoming territory behind door 201 from a power reduction mode to an operation mode, at the same time, performs antecedent illumination by brightening dimmed lamp (not shown) mounted light fixture 203 in said oncoming territory anterior to occupant 255 is visually exposed to the territory, or visually detects brightening in the territory behind door 201 from dimmed. As door 201 closes, interactive sensor 220 enters the closed state wherein contact plate 220-2 is reverted to a position facing sensing plate 220-1 while interactive sensor 220 sends a signal to the controller.

While located within territory 200, occupant 255 is detected by occupancy sensor 205.

In an alternative embodiment, occupant 255 exiting from territory 200 while withdrawing key card 261 from, or entering into the territory behind normally closed door 201 by bringing key card 261 to interactive sensor 260 as card reader, which performs read-out of information stored in chip imbedded key card 261 and sends a signal to controller 230 to perform antecedent illumination by brightening to attain lighting intensity up to preconfigured percentages of full lumens in brightness in accordance with a unique lighting scene created by light fixture 203 installed in the territory behind door 201 before closed door 201 (not shown) is opened at all, or to an extent sufficient for occupant 255 to be visually exposed to the territory, or to visually detect brightening in the territory behind door 201 from dimmed.

The interactive sensor may include a variety of technologies that operate on the principle of detecting occupant initiated action followed by opening/closing of a normally closed door partitioning two territories in the occupant traversal path. Some technologies and methods constituting the interactive sensor, including but not limited to:

Compression switch (not shown) for detection of the turn of the bolt (not shown) or door latch 222 of the door lock, sending signals when compressed or released;

Capacitance Sensor 222: capacitance sensing on door latch 223;

Key Card Reader 260: information read-out of key card 261.

These technologies can be used alone or in combination to provide information about an occupant initiated action and tagging of identity related an occupant resided building unit:

PIR based occupancy sensor 205: passive infrared motion sensor for detection of occupant approaching a normally closed door segregating two territories in a building zone;

Image Sensor 240: occupant image capturing;

Smart Floor 270: exerted weight sensing;

RFID reader 260: detecting an RFID tag 280 in a key holder, or, worker's permit/key card/smart card;

WiFi access point 290: detecting the WiFi adapter in a PDA, cellular phone, etc.

While the above represent various current sensor technologies, new sensors enabled by technological advancements and sensor model improvements will not alter the operation principle of the interactive sensor or limit the scope of functionality in the present utility control system and thus such improved sensors are contemplated for use in the present invention.

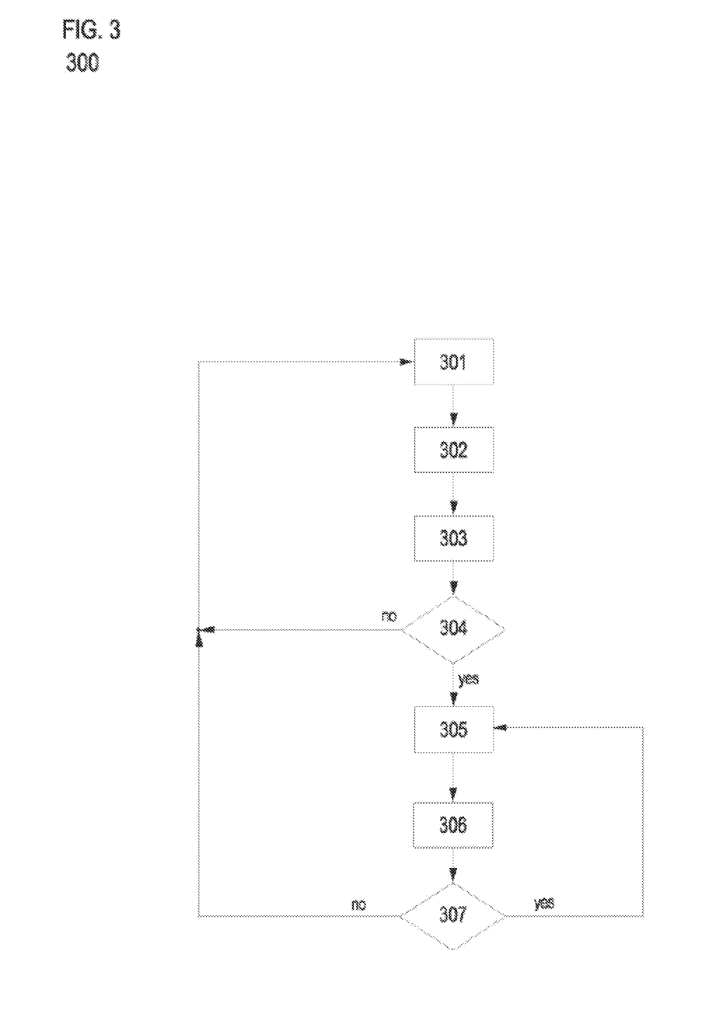

FIG. 3 is a flow diagram of control method 300 illustrating the utility control system in operation with the ECS.

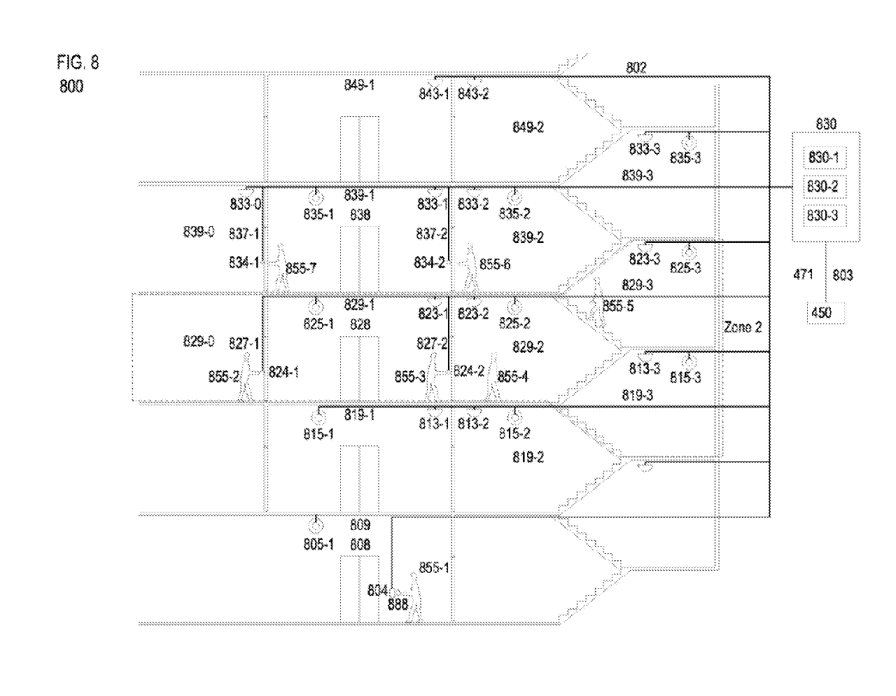

In step 301, a building zone in FIG. 8 including non-common use territory residence unit 839-0, common use territories 839-1, 839-2, are unattended—light fixtures 833-1, 833-2, are dimmed by controller 830 executed illumination extinguishment after completing an occupancy verification process in territories 839-1, 839-2.

In step 302, interactive sensor 804 as card reader of data imbedded integrated circuit card, or “smart card”—linked to controller 830 via communicative linkage 802 and installed in normally brightened common use territory lobby 809—detects occupant in position 855-1 initiated action through performing information read-out of smart card 888, prior to occupant in position 855-1 traversing in an occupant traversal path by entering through elevator doors 808 to ride on a servicing car (not shown) for traversing through elevator hall 839-1 and entering residence unit 839-0 as destination territory; ECS 450 of the elevator system (not shown) receives interactive sensor 804 sent occupant identity related data from controller 830 and provides elevator service by landing a servicing car (not shown) on the floor level of lobby 809, then sends information 471 via communicative linkage 803 to controller 830 pertaining to the landing schedule of the servicing car (not shown) on the floor level of residence unit 839-0.

In step 303, controller 830 provides HVAC as well as, antecedent illumination in elevator hall 839-1 as territory of entry and territory 839-2 as territory of vicinity to occupant entry, in accordance with clock/timer 830-3 of controller 830 and ECS 450 sent information 471 encompassing scheduling of servicing car (not shown) landing in elevator hall 839-1 and opening of elevator doors 838, and assigns grace time period 1 having a time span commencing from the opening of elevator doors 838 to the servicing car (not shown) departing, which is sufficient for the expected arriving occupant (not shown) to step out of the landed servicing car (not shown) and be detected by occupancy sensor 835-1: controller 130 brightens light fixtures 833-1, 833-2—by effectively attaining lighting intensity up to preconfigured percentages of full lumens in brightness attributing to a unique lighting scene in each of those territories in accordance with memory 830-2 stored identity of the expected arriving occupant, whose identity was memory 830-2 stored and interactive sensor 804 verified—after landing of the servicing car (not shown) and imminently anterior to opening of elevator doors 838 and visual contact of the expected arriving occupant (not shown) with elevator hall 839-1 for obviation from notification and visual exposure to the brightening process in elevator hall 839-1 as the territory of entry. While remaining fully dimmed are light fixtures 813-1, 813-2, 813-3, 823-1, 823-2, 823-3, 833-3, 843-1, 843-2, to serve the purpose of power conservation.

Upon the lapse of grace time period 1 in step 304, controller 830 examines memory 830-2 recorded data pertaining to occupancy sensor 835-1 detected occupancy within the duration of grace time period 1 and after the landed servicing car (not shown) has departed from elevator hall 839-1: if recorded data does not indicate occupancy detection in elevator hall 839-1, return to step 301 as the preliminary occupancy verification process is completed for controller 830 to activate illumination extinguishment by dimming light fixtures 833-1, 833-2; on the flip side, go to step 305 if memory 830-2 recorded data indicates occupancy sensor 835-1 detected occupancy in elevator hall 839-1.

In step 305, controller 830 provides continued illumination in brightened territories 839-1, 839-2.

In step 306, controller 830 receives interactive sensor 834-1 sent signal pertaining to detected occupant initiated action including but not limited to opening of door 837-1—controller 830 starts counting grace time period 2 before it lapses upon closing of door 837-1; or in an alternative embodiment, ECS 450 sent information 471 pertains to landing and departure of a servicing car (not shown)on the floor level of elevator hall 839-1—controller 830 starts counting grace time period 2 upon departure of the servicing car (not shown) before it lapses over a preconfigured time span.

In step 307, controller 830 retrieves memory 830-2 stored data for exploration of occupancy sensors 835-1, 835-2 sent signals pertaining to occupancy detection in corresponding territories 839-1, 839-2: go to step 305, if memory 830-2 stored data indicates occupancy detection within grace time period 2; go to step 301 if memory 830-2 stored data does not indicate occupancy detection within grace time period 2, as the preliminary occupancy verification process is completed for controller 830 to activate illumination extinguishment by dimming light fixtures 833-1, 833-2.

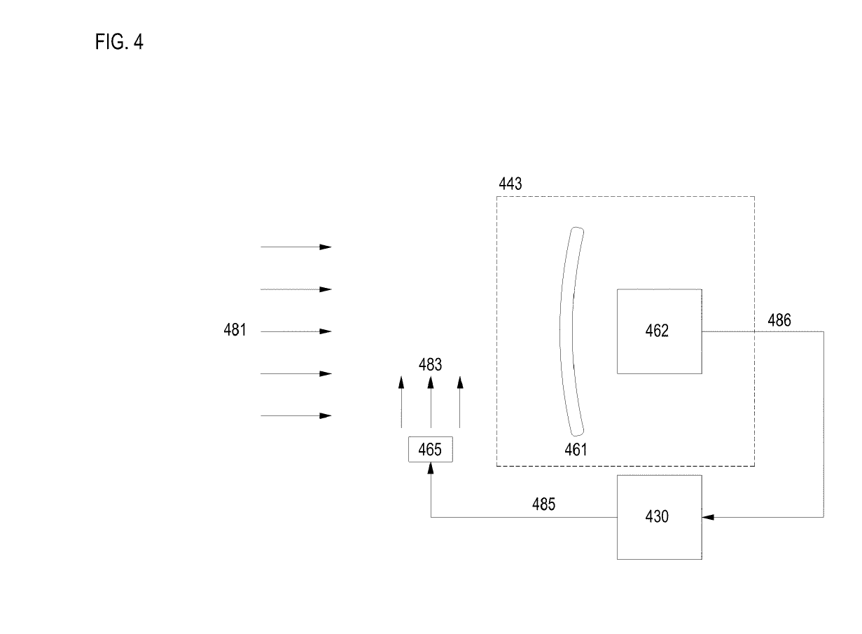

FIG. 4 demonstrates implementation of an exemplary embodiment comprising testing the operativity of a PIR sensor based occupancy sensor 443. In a regular PR sensor operation, PR sensing element 463 of PR module 462 receives IR radiation 481 emitted by a foreign entity (not shown) that is focused by sensor optics 461 including but not limited to Fresnel lens; PR module 462 generates an output signal 486 and sends it to controller 430.

In an operativity diagnosis process, an external IR radiation energy source 481 becomes unavailable; controller 430 sends signal 485 to PIR sensor based occupancy sensor 443 having an accessorized inductor 465, which emits energy 483—related to an energy source such as but not limited to heat for detection by PIR sensing element 463. PIR module 462 correspondingly sends output signal 486 to controller 430, indicating operativity of occupancy sensor 443. In contrast, failure to generate an output signal 486 by PIR module 462 indicates inoperativity of occupancy sensor 443.

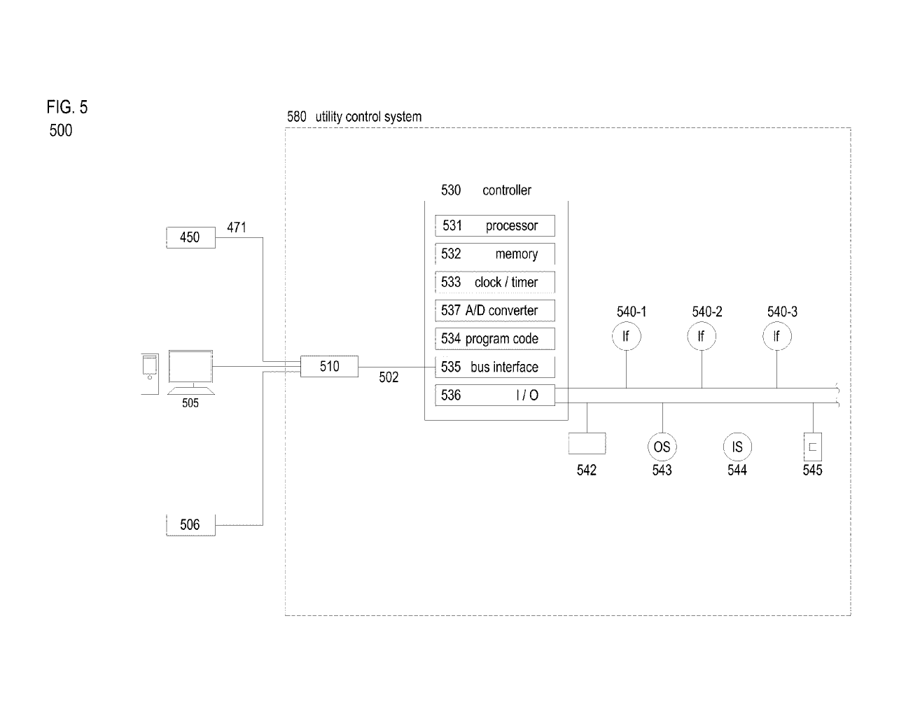

An exemplary architecture 500 is illustrated in FIG. 5, wherein a modular utility control system 580 constituting to a distributed intelligence system with high granularity is communicatively linked (wired or wireless) with ECS 450, client 505 and BMS 506 through hub 510. In one embodiment, controller 530 receives configurations and commands from client 505 and/or BMS 506; in return, client 505 and BMS 506 receive real-time and archived operation information of utility control system 580.

Controller 530 comprises a processor 531, memory 532, clock/timer 533, program code 534, interface 535, input/output gateway (“I/O”) 536 and AD converter 537. Memory 532, working with or within controller 530, can be any device, including magnetic, optical or solid-state memory comprising random access memory (“RAM”), nonvolatile memory such as Electrically Erasable Programmable Read Only Memory (“EEPROM”) which is connected to processor 531 and to other components of controller 530; memory stored information can be changed via communicatively connected thin client 505 or BMS 506.

Controller 530 receives/retrieves information 471 from ECS 450 through communicative linkage 502, including one or more of the following (but not limited thereto):

car landing and departure pertaining to elevator services provided in response to prompted car calls and the floor levels corresponding to those car calls;

real-time locations of said passengers;

timing and scheduling of car landing/departing;

car load and increase/decrease in car load after car landing/departing;

car doors opening/closing pertaining to car landing/departing;

detected passenger identification in correspondence with active sensing technology, for example, user identification through RFID chip or WiFi adapter equipped PDA and cellular phone and similar technologies with identifiable wireless tags embedded in portable or personal belongings.

Controller 530 sends information 471 to ECS 450 through communicative linkage 502, including one or more of the following (but not limited thereto):

real-time occupancy and number of occupants in building territories demanding elevator services and the related floor levels, including but not limited to the elevator hall, corridors, stairs and parking garage, etc.;

recorded occupancy and number of occupants in accordance with time and day.

Information 471 is utilized by controller 530 in operation, in one or more of the following ways:

activating provision of antecedent illumination in territories including but not limited to the elevator hall as common use territory in a building zone anterior to passenger unboarding from the landing car; and

executing the occupancy verification process, following with activating illumination extinguishment by terminating provision of lighting in unattended, antecedent illuminated provided territories upon the lapse of a preconfigured grace time period entailed in the antecedent illumination, or, following occupant departure through a departing car.

Controller 530 receives/retrieves and processes real-time operation information sent from other systems through interface 535 for activation of on-demand antecedent lighting provision and occupancy verification process for ascertainment of total occupant departure from said territories in the corresponding landing floor and terminates provision of lighting and optional utilities as in HVAC, including one or more of the following:

commands and operation information from client 505 and BMS 506;

Through I/O 536, controller 530 controls activation and termination of utility provision by switching selected electrical devices including but not limited to a plurality of light fixtures 540, between an operation mode and a power reduction mode, including one or more of:

receiving real-time signals in accordance with clock time from elevator car detection section 542 detecting car arrival and car departure; occupancy sensor 543, interactive sensor 544, override switch 545;

brightening and dimming lamp mounted light fixtures 540-1, 540-2, 540-3.

Processor 531 processes incoming signals via I/O 536 and executes preinstalled programs in program code 534. Data is stored in memory 532 while commands are sent or executed in conformity with clock/timer 533. Communications are performed via interface 535 with other systems that are linked to linkage 502 through hub 510. Incoming analog signals are converted to digital data by AD converter 537.

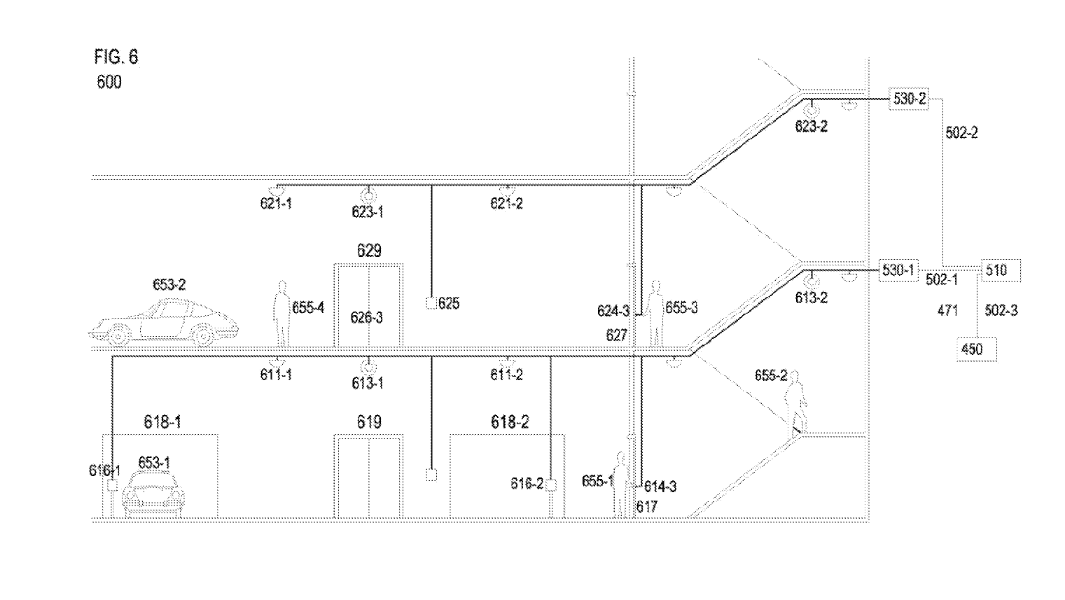

In an embodiment as illustrated in FIG. 6, occupant in position 655-3 and occupant in position 655-4 represent the locations of an occupant with respect to two instantaneous times t1, t2, pertaining to two synchronized clock/timers (see clock/timer 533 in FIG. 5) individually integrated into controllers 530-1, 530-2: the occupant is located in position 655-3 before opening normally and concurrently closed door 627, and in position 655-4 after opening and traversing through door 627. At instantaneous time t1, interactive sensor 624-3 detects occupant in position 655-3 prompted occupant initiated action—such as approaching toward closed door 627, touching the door 627 installed door knob (not shown), turning the door bolt (not shown) with the door knob (not shown), opening door 627, etc.—and transmits a signal via linkage 502-2 to controller 530-2.

The control system—comprising communicative linkages 502-1, 502-2, 502-3, controllers 530-1, 530-2, gate card readers 616-1, 616-2, hub 510, interactive sensors 614-3, 624-3, lamps (not shown) mounted normally dimmed light fixtures 611-1, 611-2, 621-1, 621-2, occupancy sensors 613-1, 613-2, 623-1, 623-2—provides on-demand lighting comprising antecedent illumination along a possible, projected occupant traversal path in the parking garage 600—encompassing vehicle use driveway ramp adjoined (not shown) parking garage territories 619, 629 located on two separate floor levels—for occupant in position 655-3 to depart through exit 618-2 in parking garage territory 619 by driving vehicle in position 653-2 parked in parking garage territory 629, through asynchronously brightening, or, synchronously brightening parking garage territories 619 and 629.

In accordance with the control system asynchronously activated antecedent illumination in the possible, projected occupant traversal path: firstly, controller 530-2 brightens to effectively attain a preconfigured percentage of full lumens in brightness lamps (not shown) mounted dimmed light fixtures 621-1, 621-2—installed in parking garage territory 629 located on the same floor level as the immediately adjoining, door 627 segregated, occupant in position 655-3 located territory—before closed door 627 is opened at all, or to an extent that occupant in position 655-3 is able to visually detect the lighting conditions in parking garage territory 629 as dimmed or brightening from dimmed, and at the same time transports signal α (not shown) through linkages 502-1, 502-2 and hub 510 to controller 530-1; secondly, at posterior instantaneous time t2, occupancy sensor 623-1 transports signal β (not shown) to controller 530-2 via linkage 502-2 upon detecting occupant in position 655-4, beyond which the occupant will be visually exposed to parking garage territory 619, or able to visually detect the lighting conditions in parking garage territory 619 as dimmed or brightening from dimmed, controller 530-2 transports signal β (not shown) to controller 530-1 via linkages 502-2, 502-1 and hub 510—controller 530-1 in turn brightens to effectively attain a preconfigured percentage of full lumens in brightness lamps (not shown) mounted dimmed light fixtures 611-1, 611-2—installed in parking garage territory 619 and located on a different floor level to vehicle use driveway ramp adjoined (not shown), occupant in position 655-4 located parking garage territory 629.

In accordance with the control system synchronously activated antecedent illumination in the possible projected occupant traversal path: brightening to effectively attain a preconfigured percentage of full lumens in brightness lamps (not shown) mounted dimmed light fixtures 621-1, 621-2 installed in parking garage territory 629, as well as, lamps (not shown) mounted dimmed light fixtures 611-1, 611-2 installed in parking garage territory 619 before door 627 is opened at all, or to an extent that occupant in position 655-3 is able to visually detect the lighting conditions in parking garage territory 629 as dimmed or brightening from dimmed.

Controllers 530-2 and 530-1 provide for occupant in position 655-3; undisrupted and continuous illumination within parking garage territories 619, 629 is provided by continuously brightened light fixtures 611-1, 611-2, 621-1, 621-2, and after an occupancy verification process is performed.

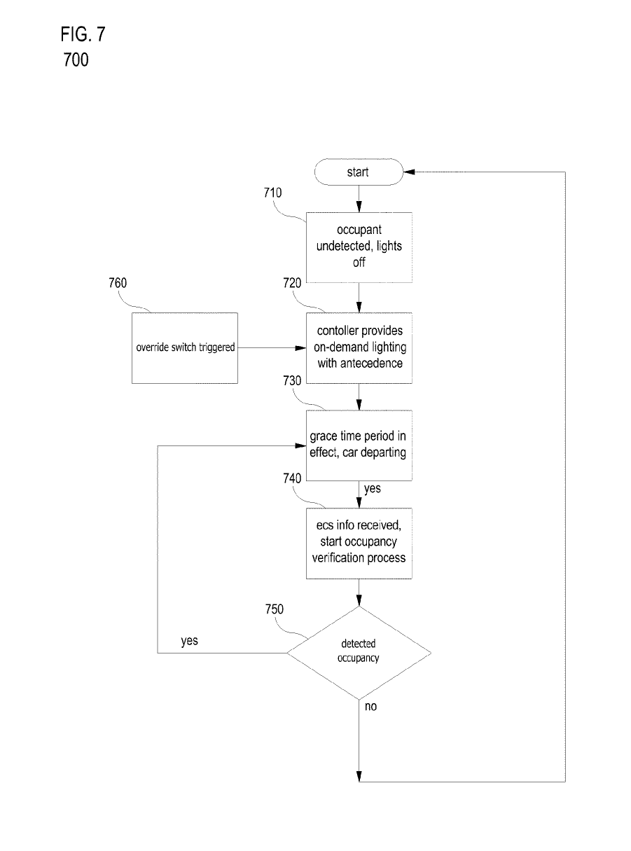

In FIG. 7, a flow diagram illustrates illumination extinguishment upon completion of the occupancy verification process pertaining to on-demand lighting in control method 700. Referring to parking garage 600 in FIG. 6, controller 530-1 monitors occupancy in parking garage territory 619 through occupancy sensor 613-1; controller 530-2 monitors occupancy in parking garage territory 629 through occupancy sensor 623-1.

In step 710, controller 530-2 activates illumination extinguishment by dimming normally dimmed and concurrently brightened light fixtures 621-1, 621-2 as controller 530-2 determines that parking garage territory 629 is unattended with occupancy.

In step 720, the driver (not shown) of vehicle in position 653-1 entering through entrance 618-1 into unattended parking garage territory 619 performs information read-out of a smart card (not shown) with gate card reader 616-1, which sends the corresponding information pertaining to location of vehicle parking space in position 653-2 and therefore a projected occupant (vehicle) traversal path from gate card reader 616-1, driver's residence floor and unit (not shown) to controllers 530-1, 530-2.

Controllers 530-1, 530-2 activate antecedent illumination by brightening normally and concurrently dimmed light fixtures 611-2, 621-1, 621-2 anterior to vehicle in position 653-1 passing an area in parking garage territory 619 that is continuously illuminated by normally brightened light fixture 611-1 toward parking space in position 653-2, such that the occupant as driver (not shown) of vehicle in position 653-1 is evaded from visual exposure to the lighting conditions in parking garage territories 619, 629 as dimmed or brightening from dimmed, and provides undisrupted illumination for the visiting occupant (not shown) of vehicle in position 653-1 to park the vehicle in parking space in position 653-2, and depart from parking garage territory 629 through elevator doors 626-3 or door 627.

In step 730, controller 530-2 activates a count-down on a grace time period with the integrated clock/timer 533 (see FIG. 5); occupant in position 655-4 has parked the vehicle in position 653-2 and departs from parking garage territory 629 through elevator doors 626-3 into a departing car (not shown).

In step 740, controller 530-2 receives/retrieves information 471 related to the real-time ECS 450 operation—and activates the occupancy verification process in step 750, including:

processing data pertaining to interactive sensors 614-3, 624-3 for detection of door opening (implying possibility in occupant making entry/exit), gate card reader 616-1 for detection of vehicle entry into parking garage territory 619 through entry 618-1 and gate card reader 616-2 for detection of vehicle departure from parking garage 600 through exit 618-2;

processing selected data of ECS 450 sent information 471;

processing selected data of clock/timer 533 (see FIG. 5);

analyzing occupancy sensors 613-1, 623-1 sent signals for detecting occupancy within parking garage territories 619, 629.

In addition, controller 530-2 optionally processes commands and operation information from client 505 and BMS 506, if any. Return to step 710 in the event that controllers 530-1, 530-2 determine that parking garage territories 619, 629 are unattended with occupancy, and to activate illumination extinguishment within by dimming light fixtures 611-2, 621-1, 621-2. Return to step 730 and extend illumination in parking garage territories in the event that occupancy is detected by occupancy sensors 613-1, 623-1 within parking garage territories 619, 629.

In step 760, controller 530-2—receiving an override switch 625 signal activated by an undetected occupant (not shown) in dimmed elevator hall 629—instantly assigns an extension time period to said occupant and brightens light fixtures 621-1 and 621-2. The extension time period having a countdown for extension of illumination is similar to the grace time period.

As illustrated in FIG. 8, control system 830 provides building 800 with antecedent illumination and HVAC—wherein, emergency exit doors 827-2, 837-2, and doors 827-1, 837-1 segregating non-common use territories residence units 829-0, 839-0 and common use territories 829-1, 839-1 are normally closed; the common use territories are normally dimmed (unless otherwise specified).

In the first embodiment, occupant in position 855-2 located in unit 829-0 prompts an occupant initiated action by opening normally and concurrently fully closed door 827-1—interactive sensor 824-1 as door sensor detects the occupant initiated action as door 827-1 is opening and sends a signal to control system 830 via communicative linkage 802. Before door 827-1 is opened at all, or to an extent to allow occupant in position 855-2 to be visually exposed to the lighting conditions in territory 829-1 as dimmed or brightening from dimmed, control system 830 has performed antecedent illumination by amply brightening normally and concurrently dimmed light fixtures 813-3, 823-1, 823-2 and 823-3 installed in respective common use territories 819-3, 829-1, 829-2, 829-3, to effectively attain lighting intensities up to preconfigured percentages of full lumens in brightness in accordance with a unique lighting scene in each of those territories anterior to visual contact of occupant in position 855-2 made with territory 829-1 as the territory of immediate entry for obviation of occupant in position 855-2 from visual exposure and notification to the brightening process in the territory of entry.

Frosted glass (not shown) installed emergency exit door 827-2 disperses light emitted by light fixtures 813-3, 823-2 and 823-3 possible to be visually recognized by an occupant located in territory 829-1—including but not limited to occupant in position 855-3. Occupant in position 855-2 consecutively opens (not shown) door 827-1, steps into (not shown) brightened territory 829-1, and enters a car (not shown) through elevator doors 828 for traveling to other floor levels of building 800.

In this embodiment, control system 830 activates antecedent illumination for occupant in position 855-2 by brightening light fixture 823-1 installed in territory 829-1 of occupant entry notwithstanding, as well light fixtures 813-3, 823-2 and 823-3 installed in respective common use territories 819-3, 829-2, 829-3—which are directly and indirectly adjoined to territory 829-1 of entry by occupant in position 855-2. Even though interactive sensor 824-1 signals sent to control system 830 do not indicate that occupant in position 855-2 will be crossing emergency exit door 827-2 for entry into territories 819-3, 829-2, 829-3, once within territory 829-1, the occupant may be possibly in position 855-3 to detect the lighting conditions as dimmed in territories 819-3, 829-2, 829-3 through the frosted glass (not shown) imbedded in emergency exit door 827-2.

In other words, dimmed common use territories with occupant initiated action demonstrating no certainty of entry by occupant located in a territory not visually exposed to the occupant—in territory prior to or after making entry into the territory of entry—remain dimmed; whereas, dimmed common use territories with occupant initiated action demonstrating no certainty of entry by occupant located in an adjoining territory on the same floor level, or cross-over, indirectly adjacent territory on the same, or a different floor level but possible to be visually exposed to the occupant in territory prior to or after making entry into the territory of entry are brightened with antecedent illumination in accordance with on-demand lighting.

In the second embodiment, control system 830 provides illumination at least in common use territories 829-3, 839-1, 839-2, 839-3 through brightened respective light fixtures 823-3, 833-1, 833-2, 833-3 for occupant in position 855-7 located in territory 839-1—detected by linkage 802 linked occupancy sensor 835-1—prompts an occupant initiated action by turning normally and concurrently fully closed door 837-1 installed door knob (not shown) prior to entering concurrently dimmed light fixture 833-0 installed residence unit 839-0—interactive sensor 834-1 as door sensor detects the occupant initiated action and sends a signal to control system 830 via linkage 802. Before door 837-1 is opened at all, or to an extent to impose on occupant in position 855-7 visual exposure to the lighting conditions in territory 829-1 as dimmed or brightening from dimmed, control system 830 has performed antecedent illumination by duly brightening dimmed light fixture 833-0 to effectively attain lighting intensities up to preconfigured percentages of full lumens in brightness in accordance with a unique lighting scene in residence unit 839-0. (Different scenes may be orchestrated in residence unit 839-0 by having different intensities in lumens in different light fixtures, including but not limited to light fixture 833-0.)

At the same time, control system 830 starts counting a grace time period: ECS 450 sent information 471 does not indicate landing of servicing car on the floor level of elevator hall 839-1, but signals receiving from occupancy sensors 825-3, 835-1, 835-2, 835-3 indicate detection of occupancy sensors 825-3, 835-2 detected respective occupants in positions 855-5, 855-6. Subsequently, occupant in position 855-7 opens (not shown) door 837-1 to an extent to become visually exposed to brightened residence unit 839-0, steps into (not shown) residence unit 839-0—said grace time period lapses upon control system 830 receiving interactive sensor 834-1 sent signal pertinent to door 837-1 closing. Control system 830 continues to provide illumination at least in common use territories 829-3, 839-1, 839-2, 839-3 through brightened respective light fixtures 823-3, 833-1, 833-2, 833-3.

In the third embodiment, common use territories 819-3, 829-1, 829-2 and 829-3 are concurrently brightened in accordance with a unique scene for occupant in position 855-3: normally dimmed light fixtures 813-3, 823-3 are moderately brightened at 50% lighting intensity, whereas normally dimmed light fixtures 823-1, 823-2 are brightened at 100% lighting intensity; occupant in position 855-3 located in territory 829-1 performs an occupant initiated action by opening emergency exit door 827-2. Through the frosted glass (not shown) installed in emergency exit door 827-2, occupant in position 855-3 visually notices lighting conditions in territory 829-2, but is unable to notice lighting conditions in territories 819-2 and 839-2, respectively installed with light fixtures 813-2, 833-2. Interactive sensor 824-2 as door sensor detects said occupant initiated action and sends the corresponding signals through linkage 802 to control system 830, which activates antecedent illumination for occupant in position 855-3: prior to door 827-2 is opened at all, or to an extent to inflict on occupant in position 855-3 visual exposure to the lighting conditions in territories 819-3, 829-3 changing from moderately brightened at 50% lighting intensity to brightened at 100% lighting intensity, control system 830 brightens light fixtures 813-3, 823-3 to attain 100% lighting intensity and moderately brightens light fixtures 813-2 and 833-2 to attain 50% lighting intensity. Subsequently, occupant in position 855-3 opens emergency exit door 827-2, reaches position 855-4 and position 855-5 in common use territory 829-3.

In this embodiment, control system 830 activates antecedent illumination for occupant in position 855-3 by moderately brightening to attain 50% lighting intensity light fixture 833-2 installed in territory 839-2 located on a different floor level upon detection of said occupant initiated action, which demonstrates occupant in position 855-3 entry through adjoining territories 829-2, 829-3, by sequentially reaching position 855-4, and position 855-5 in one route alternative of a projected occupant traversal path. At the same time, control system 830 also activates antecedent illumination in territory 819-2 as the unvisited route alternative of the projected occupant traversal path having equal possibility of visit in accordance with interactive sensor 824-2 sent signals pertaining to said detected occupant initiated action sent to control system 830: by moderately brightening to attain 50% lighting intensity light fixture 813-2 installed in common use territory 819-2 located on a different floor level.

In the final embodiment, occupancy sensor 825-2 sending a signal through wired and wireless network 802 to controller 830 in accordance with detecting occupant in position 855-4 in common use territory 829-2; controller 830 starts counting with clock/timer 830-3 at instantaneous time t1. At instantaneous time t2, the occupant traversing through the stairway in common use territory 829-3 in position 855-6 is detected by interactive sensor 825-3, which sends a signal through wired and wireless network 802 to controller 830. The time span between t1 and t2 is within a preconfigured threshold tolerance.

Occupant in position 855-5 stops traversing for a while, before arriving in position 855-6 at instantaneous time t3 and is detected by occupancy 835-2. The time span between t2 and t3 is beyond a preconfigured threshold tolerance: controller sends a first message through wired and wireless network 802 to mobile device 888 held by user in position 855-1. Occupant in position 855-6 moves to position 855-7 while controller 830 receives an occupancy sensor 835-1 sent signal for occupant detection at instantaneous time t4. However, a preconfigured threshold tolerance is exceeded before interactive sensor 834-1 sending any signal indicating opening of door 837-1 for entry into non-common use territory unit 839-0; in converse, interactive sensor 834-2 does not send any signal indicating opening of door 837-2 for exit into non-common use territory unit 839-2; in furtherance, ECS 450 sent information 471 neither indicates prompted car call for elevator service, nor landing of servicing car on the floor level of elevator hall 839-1 with passenger boarding a departed servicing car. Controller 830 sends a second message to user in position 855-1 held mobile device 888 through wired and wireless network 802.

It will be apparent to those skilled in the art that various modifications and variations can be made without departing from the scope or spirit of the present invention of the utility control system. The above examples are merely exemplary implementations of a particular system, with the true scope and spirit of the invention being indicated in the claims.

What is claimed is:

1. A method for providing lighting and utility in a building that comprises a plurality of floor levels, stairways, one or more normally closed building doors, one or more elevator doors, at least one building zone encompassing at least one building territory for non-common use, at least one building zone encompassing one or more building territories for common use, at least one parking garage, and an elevator control system having a communicative linkage with at least one controller for controlling light fixtures and HVAC, a territory of entry being defined as a territory immediately entered by an occupant who causes a detected occupant-initiated action, an activity building door being defined as an activity signal related to a normally closed building door, a territory of vicinity being defined as the territory of entry adjoined a common-use territory with limited lighting conditions visually exposed to the territory of entry yet not of immediate or intended occupant entry in accordance with said detected occupant-initiated action, the method comprising:
(a) in response to the detected occupant-initiated action, generating an activity signal;
(b) ascertaining the light fixtures disposed in a territory of entry and one or more territories of vicinity to be deactivated;
(c) generating an activation signal for the activity signal;
(d) transmitting the activation signal to the deactivated light fixtures disposed in the territory of entry and the one or more territories of vicinity;
(e) in response to the activation signal, activating the deactivated light fixtures disposed in the territory of entry and the one or more territories of vicinity in accordance with on-demand lighting and one or more unique lighting scenes;
(f) starting counting a grace time period when the activity signal is generated;
(g) commencing an occupancy verification process when the activity signal is generated, wherein the occupancy verification process comprises generating a deactivation signal for the activity signal when occupancy within the territory of entry and the one or more territories of vicinity is not detected upon lapse of the grace time period, and transmitting the deactivation signal to activated light fixtures disposed in the territory of entry and the one or more territories of vicinity so as to enact illumination extinguishment of said activated light fixtures;
(h) receiving, from the elevator control system through the communicative linkage, a real-time schedule of landing and departing with respect to floor levels of at least one operating elevator car;
(i) receiving, from the elevator control system through the communicative linkage, signals and real-time operation information for elevator car door opening/closing; and
(j) receiving, from the elevator control system through the communicative linkage, signals and real-time operation information for passenger boarding and alighting pertinent to car landing on each floor level of entry.

2. The method according to claim 1, further comprising:
(a) generating an activity signal in an attended territory of entry when an occupant is detected;
(b) performing:
(b.1) generating an activity signal for the detected occupant-initiated action pertaining to an activity building door disposed in the territory of entry, and generating a secondary activity signal for the activity signal after receiving the activity signal in the attended territory of entry pertinent to an occupancy sensor disposed at a shortest distance from said activity building door; or
(b.2) generating an activity signal for information read-out of a data-imbedded integrated circuit card, and generating a secondary activity signal for the activity signal after receiving the activity signal in the attended territory of entry pertinent to an occupancy sensor disposed at a shortest distance from the data-imbedded integrated circuit card pertinent to a parking space in a parking garage;
(c) performing:
(c.1) ascertaining light fixture disposed in a territory of entry that is a non-common use territory to be deactivated; or
(c.1) ascertaining light fixtures disposed in a territory of entry and one or more territories of vicinity to be deactivated;
(d) generating an activation signal for the secondary activity signal;
(e) performing:
(e.1) transmitting the activation signal to the deactivated light fixture disposed in the territory of entry that is a non-common use territory; or
(e.2) transmitting the activation signal to the deactivated light fixtures disposed in the territory of entry and the one or more territories of vicinity;
(f) performing:
(f.1) in response to the activation signal, activating the deactivated light fixture disposed in the territory of entry that is a non-common use territory in accordance with on-demand lighting, controller memory means stored information pertinent to the territory of entry that is non-common use territory and controller clock/timer clock time for creating a unique lighting scene; or
(f.2) in response to the activation signal, activating the deactivated light fixtures disposed in the territory of entry and the one or more territories of vicinity in accordance with on-demand lighting and one or more unique lighting scenes;
(g) starting counting a grace time period when the activity signal is generated; and
(h) commencing an occupancy verification process when the secondary activity signal is generated, the occupancy verification process comprises generating a deactivation signal for the secondary activity signal when occupancy within the territory of entry and the one or more territories of vicinity is not detected upon lapse of the grace time period, and transmitting the deactivation signal to the activated light fixtures disposed in the territory of entry and the one or more territories of vicinity so as to enact illumination extinguishment of said activated light fixtures.

3. The method according to claim 2, further comprising:
(a) generating an activity signal in attended territory of entry for a detected occupant in a territory of entry;
(b) generating a primary activity signal for a selected activity signal in attended territory of entry;
(c) recording the primary activity signal;
(d) with a reporting time being defined as the corresponding clock time of a controller clock/timer, counting with said controller clock/timer a maneuvering time duration commencing from the reporting time to the clock/timer clock time of a corresponding activity signal pertinent to an entity disposed at a shortest distance from a sensor pertinent to said primary activity signal, wherein said entity is one of:
(d.1) an activity building door disposed with an interactive sensor generating said activity signal;
(d.2) an activity elevator door corresponding to a landing elevator car pertinent to said activity signal; and
(d.3) an occupancy sensor;
(e) generating a prime signal in accordance with the maneuvering time duration exceeding a pre-determined time threshold value, wherein the sensor pertinent to the primary activity signal is further characterized as;
(e.1) being neither disposed at a shortest distance from an activity building door, an activity elevator door, or a parking garage exit; or
(e.2) being disposed at a shortest distance from an activity building door or an activity elevator door without a corresponding activity signal; or
(e.3) being disposed at a shortest distance from an activity elevator door with a corresponding activity signal for an elevator car landed on the floor level of entry departing without passenger boarding the elevator car; and
(f) sending a message in accordance with the prime signal to a client computer through the communicative linkage.

4. The method according to claim 1, further comprising:
(a) receiving signals and real-time operation information from a communicatively linked elevator control system;
(b) generating an activity signal prior to an elevator car landing and opening elevator door on a floor level of entry, where the floor level of entry is defined as a territory pertinent to a landing elevator car with an alighting occupant making entry into a territory of entry and a floor level of the territory of entry;
(d) ascertaining light fixtures disposed in a territory of entry and one or more territories of vicinity to be deactivated;
(e) generating an activation signal for the activity signal;
(f) transmitting the activation signal to the deactivated light fixtures disposed in the territory of entry and the one or more territories of vicinity;
(g) in response to the activation signal, activating the deactivated light fixtures disposed in the territory of entry and the one or more territories of vicinity in accordance with on-demand lighting and one or more unique lighting scenes;
(h) starting counting a grace time period when the activity signal is generated;
(i) commencing an occupancy verification process when the activity signal is generated, wherein the occupancy verification process comprises generating a deactivation signal for the activity signal when occupancy within the territory of entry and the one or more territories of vicinity is not detected upon lapse of the grace time period, and transmitting the deactivation signal to the activated light fixtures disposed in the territory of entry and the one or more territories of vicinity so as to enact illumination extinguishment of said activated light fixtures.

5. The method according to claim 1, further comprising:
(a) generating an activity signal in an attended territory of entry for a detected occupant in a territory of entry on a floor level of entry, where the floor level of entry is defined as the floor level of said territory of entry;
(b) generating an activity signal prior to an elevator car landing and opening an elevator door on the floor level of entry;
(c) generating a secondary activity signal for the departing elevator car landed on the floor level of entry after receiving an activity signal in the attended territory of entry pertinent to an occupancy sensor disposed at a shortest distance from an activity elevator door, where the activity elevator door is defined as a territory disposed with an elevator door with detected occupancy a territory of entry and the elevator door;
(d) starting counting a grace time period when the activity signal is generated; and
(e) commencing an occupancy verification process when the secondary activity signal is generated, wherein the occupancy verification process comprises generating a deactivation signal for the secondary activity signal when occupancy within the territory of entry and the one or more territories of vicinity is not detected upon lapse of the grace time period, and transmitting the deactivation signal to the activated light fixtures disposed in the territory of entry and the one or more territories of vicinity so as to enact illumination extinguishment of said activated light fixtures.

6. The method according to claim 1, wherein the occupant-initiated action comprises:
(a) opening an activity building door;
(b) retracting an activity building door disposed latch bolt by turning a door knob for opening the door;
(c) performing information read-out of a data-imbedded integrated circuit card with a card reader; and
(d) traversing through the stairs of a stairway.

7. The method according to claim 1, wherein activating one light fixture pertains to brightening one or more lamps mounted in the light fixture by effectively attaining lighting intensities up to preconfigured percentages of full lumens in brightness for creating a user-defined, preconfigured unique lighting scene.

8. The method according to claim 7, wherein the one or more lamps are one or more of a light emitting diode, a halogen lamp and an incandescent lamp.

9. The method according to claim 1, wherein a unique lighting scene is created in accordance with the controller clock/timer clock time, scene data specifying the intensity of illumination in each lamp mounted in a light fixture as preconfigured by user through a communicatively-linked client computer and stored in a controller memory means.

10. The method according to claim 1, wherein the on-demand lighting comprises:
(a) providing antecedent illumination in a territory of entry as non-common use territory;
(b) providing antecedent illumination and enacting the occupancy verification process in the territory of entry and the one or more territories of vicinity; and
(c) enacting illumination extinguishment.

11. The method according to claim 10, wherein the on-demand lighting provided in a territory of vicinity pertains to activating the deactivated light fixture disposed in the territory of vicinity, and the on-demand lighting is arranged to perform:
(a) synchronous activation in accordance with the transmitted activation signal; and
(b) asynchronous activation in accordance with an activity signal in an attended territory of entry pertinent to an occupancy sensor disposed at a location in the territory of entry, beyond which the corresponding detected occupant is visually exposed to brightening from a dimming state of the territory of vicinity.

12. The method according to claim 10, wherein the antecedent illumination is provided through sequentially activating selected light fixtures disposed in the territory of entry, the one or more territories of vicinity anterior to an occupant's visual exposure and entry into the territory of entry, so as to obviate the occupant from exposure to a brightening process of the selected light fixtures in the territory of entry.

13. The method according to claim 1, wherein the illumination extinguishment pertains to deactivating one or more light fixtures, which are totally, or partially, dimmed to low percentages of lumens in brightness for one or more lamps mounted in the light fixture.

14. The method according to claim 1, wherein continuous illumination is provided in the territory of entry and the one or more territories of vicinity during the grace time period, the grace time period further comprising one or more of:
(a) a time span commencing from the generation of an activity signal pertinent to an activity building door to the detected closing of the activity building door;
(b) a time span commencing from an elevator car door landing and/or opening to the elevator car door closing and/or departing; and
(c) a time span preconfigured in accordance with a secondary activity signal.

15. The method according to claim 1, wherein the occupancy verification process commences in accordance with the activity signal prior to the illumination extinguishment in one or more common use territories, and wherein the occupancy verification process comprises:
(a) detecting occupancy in the territory of entry and the one or more territories of vicinity in accordance with the activity signal pertinent to an activity building door;
(b) detecting occupancy in a territory of entry and one or more territories of vicinity in accordance with the activity signal pertinent to an activity elevator door;
(c) detecting occupancy in the territory entry and the one or more territories of vicinity in accordance with a secondary activity signal; and
(d) self-terminating upon occupancy detection within the territory of entry and the one or more territories of vicinity.

16. A control system for providing lighting and utility in a building that comprises a plurality of floor levels, stairways, one or more normally closed building doors, one or more elevator doors, at least one building zone encompassing at least one building territory for non-common use, at least one building zone encompassing one or more building territories for common use, at least one parking garage, and an elevator control system having a communicative linkage and including at least one controller for controlling light fixtures and HVAC, a territory of entry being defined as a territory immediately entered by an occupant who causes a detected occupant-initiated action, an activity building door being defined as a normally closed building door that responds to an activity signal, a territory of vicinity being defined as the territory of entry adjoined a common-use territory with limited lighting conditions visually exposed to the territory of entry yet not of immediate or intended occupant entry in accordance with said detected occupant-initiated action, the control system comprising:
an interactive sensor for generating an activity signal; and
a controller for receiving the activity signal sent from the interactive sensor; wherein:
the interactive sensor is disposed in an activity building door for detecting an occupant-initiated action and generating the activity signal thereupon, or is disposed in a stairway for detecting the occupant-initiated action and generating the activity signal thereupon; and
the controller is configured to:
(a) generate an activation signal for the activity signal; or;
(b) either generate a secondary activity signal for the activity signal after receiving the activity signal in the attended territory of entry pertinent to an occupancy sensor disposed at a shortest distance from said activity building door, or generate a secondary activity signal for the activity signal after receiving the activity signal in the attended territory of entry pertinent to an occupancy sensor disposed at a shortest distance from said data-imbedded integrated circuit card pertinent to a parking space in a parking garage, and generate an activation signal for the secondary activity signal;
(c) either ascertain that the light fixture disposed in a territory of entry designated as non-common use territory to be deactivated, or ascertain that the light fixtures disposed in a territory of entry and one or more territories of vicinity to be deactivated;
(d) perform:
(d.1) transmitting the activation signal to the deactivated light fixture disposed in the territory of entry designated as non-common use territory such that the transmitted activation signal activates the deactivated light fixture in accordance with on-demand lighting, information stored in a memory means and pertinent to the territory of entry designated as non-common use territory and clock/timer clock time for creating a unique lighting scene; or
(d.2) transmitting the activation signal to the deactivated light fixtures disposed in the territory of entry and the one or more territories of vicinity such that the transmitted activation signal activates the deactivated light fixtures in accordance with on-demand lighting and one or more unique lighting scenes;
(e) start counting a grace time period with a clock/timer when the activity signal is received; and
(f) enact an occupancy verification process when the secondary activity signal is generated, wherein the occupancy verification process comprises:
(f.1) generating a deactivation signal for the secondary activity signal when occupancy within the territory of entry and the one or more territories of vicinity is not detected upon lapse of the grace time period; and
(f.2) transmitting the deactivation signal to the activated light fixtures disposed in the territory of entry and the one or more territories of vicinity in accordance with illumination extinguishment.

17. The control system according to claim 16, wherein the controller is further configured to:
(a) receive an activity signal in an attended territory of entry for a detected occupant in a territory of entry;
(b) generate a primary activity signal for a selected activity signal in the attended territory of entry;
(c) record the primary activity signal such that the corresponding time recorded by a clock/timer is regarded as a reporting time;
(d) count with said clock/timer a maneuvering time duration commencing from the reporting time to the clock/timer clock time of a corresponding activity signal pertinent to an entity disposed at a shortest distance from the sensor pertinent to said primary activity signal, wherein said entity is one of:
(d.1) an activity building door disposed with the interactive sensor that generates said activity signal;
(d.2) an activity elevator door corresponding to a landing elevator car pertinent to said activity signal; and
(d.3) an occupancy sensor;
(e) generate a prime signal in accordance with the maneuvering time duration exceeding a pre-determined time threshold value, wherein the sensor pertinent to the primary activity signal is further characterized as:
(e.1) being neither disposed at a shortest distance from the activity building door or the activity elevator door; or
(e.2) being disposed at a shortest distance from the activity building door or the activity elevator door without a corresponding activity signal; or
(e.3) being disposed at a shortest distance from the activity elevator door with a corresponding activity signal for an elevator car landed on the floor level of entry departing without passenger boarding the elevator car;
(f) send a message in accordance with the prime signal to a client computer through the communicative linkage.

18. The control system according to claim 16, wherein the interactive sensor is one of:
(a) a door sensor for detecting opening and/or closing an activity building door;
(b) a door sensor for detecting retracting and/or releasing a door latch bolt disposed in an activity building door;
(c) an electronic card reader configured to perform information read-out of a data-imbedded integrated circuit card inserted by an occupant; and
(d) an occupancy sensor for detecting the occupant traversing through the stairs of a stairway.

19. The control system according to claim 16, further comprising a plurality of occupancy sensors disposed in building territories designated as common use territories, for detecting occupancy in accordance with a pre-determined detection range, and for generating the activity signal in an attended territory of entry for a detected occupant therein, wherein said plurality of occupancy sensors are configured to transmit the activity signal in the attended territory of entry to a controller in response to the activity signal generated by one of the occupancy sensors disposed at a shortest distance from an entity, the entity being one of:
(a) an activity building door;
(b) an activity elevator door; and
(c) an information read-out data-imbedded integrated circuit card pertinent to a parking space in a parking garage.

20. The control system according to claim 16, wherein the controller is further configured to:
(a) generate an activity signal prior to an elevator car landing and opening elevator door on the floor level of entry;
(b) ascertain that the light fixtures disposed in a territory of entry and one or more territories of vicinity to be deactivated;
(c) generate an activation signal for the activity signal;
(d) transmit the activation signal to the deactivated light fixtures disposed in the territory of entry and the one or more territories of vicinity such that the transmitted activation signal activates the deactivated light fixtures in accordance with on-demand lighting and one or more unique lighting scenes;
(e) start counting a grace time period with a clock/timer when the activity signal is generated; and
(f) enact an occupancy verification process when the activity signal is received, wherein the occupancy verification process comprises:
(f.1) generating a deactivation signal for the activity signal when occupancy within the territory of entry and the one or more territories of vicinity is not detected upon lapse of the grace time period; and
(f.2) transmitting the deactivation signal to the activated light fixtures disposed in the territory of entry and the one or more territories of vicinity in accordance with illumination extinguishment.

21. The control system according to claim 16, wherein the controller is further configured to:
(a) receive an activity signal in an attended territory of entry for a detected occupant in a territory of entry on a floor level of entry;
(b) generate an activity signal prior to an elevator car landing and opening elevator door on the floor level of entry;
(c) generate a secondary activity signal for the departing elevator car landed on the floor level of entry after receiving the activity signal in the attended territory of entry pertinent to an occupancy sensor disposed at a shortest distance from the activity elevator door;
(d) start counting a grace time period with a clock/timer when the activity signal is generated; and
(e) enact an occupancy verification process when the secondary activity signal is generated, wherein the occupancy verification process comprises:
(e.1) generating a deactivation signal for the secondary activity signal when occupancy within the territory of entry and the one or more territories of vicinity is not detected upon lapse of the grace time period; and
(e.2) transmitting the deactivation signal to the activated light fixtures disposed in the territory of entry and the one or more territories of vicinity in accordance with illumination extinguishment.

22. The control system of claim 16, wherein the controller further comprises a processor and a computer program, the computer program configuring the controller when loaded into the processor.

23. A method for retrofitting an existing control system to the control system of claim 16, comprising:
installing a controller;
disposing at least one building door with an interactive sensor;
disposing at least one stairway with an interactive sensor;
disposing at least one common use territory with an occupancy sensor; and
disposing a wired/wireless communicative network for linking the controller, the interactive sensors, the occupancy sensor, the controller, the at least one client computer, and the elevator control system.

24. The control system according to claim 16, wherein the client computer includes a processor-mounted, communicative-linkage-linked device for information input and display, including but not limited to a personal computer, a mobile phone, and a PDA.

25. The control system according to claim 16, wherein the building territory for common use is a common use territory comprising an elevator hall, a corridor, the parking garage, a public use washroom, and stairways.

26. The control system according to claim 16, wherein the building territory for non-common use is a non-common use territory comprising a residential unit, a hotel guest room, and an office.
